(19) United States
(12) Patent Application Publication
(10) Pub. No.: US 2011/0011528 A1
(43) Pub. Date: Jan. 20, 2011

(54) METHOD AND SYSTEM FOR FABRICATING A CONDUCTIVE PLATE

(75) Inventors: JEAH-SHENG WU, Miao-Li County (TW); JIA-SHYONG CHENG, Miao-Li County (TW); PO-SHENG SHIH, Miao-Li County (TW); CHIH-HAN CHAO, Miao-Li County (TW); CHEN FENG, Shenzhen (CN)

Correspondence Address: Altis Law Group, Inc.;ATTN: Steven Reiss, 288 SOUTH MAYO AVENUE, CITY OF INDUSTRY, CA, 91789, US

(73) Assignees: INNOCOM TECHNOLOGY (SHENZHEN) CO., LTD., Shenzhen City (CN); CHIMEI INNOLUX CORPORATION, Miao-Li County (TW)

(21) Appl. No.: 12/830,428

(22) Filed: Jul. 5, 2010

(30) Foreign Application Priority Data
Jul. 17, 2009 (CN) 200910304495.6

(51) Int. Cl. B32B 38/10

(52) U.S. Cl. 156/247; 156/510; 156/379.6

(57) ABSTRACT

A method for fabricating a conductive plate includes providing a base substrate and a conductive material that includes a plurality of nanounits. The conductive material is placed on the base substrate, where a portion of the conductive material placed on the base substrate is removed.

### BACKGROUND OF THE DISCLOSURE

1. Field of the Disclosure

The present disclosure relates to a method and a system for fabricating a conductive plate, and more particularly to a method and a system involving laser treatment of a conductive film of a nanomaterial on a substrate for fabricating a conductive plate.

2. Description of Related Art

Carbon nanotubes (CNTs) can exhibit a property of metal or a property of a semiconductor depending on the shape and the size thereof Since the carbon nanotubes are conductive, they can be made into a conductive film. One such method of forming the conductive film of the carbon nanotubes includes forming a cluster of carbon nanotubes on a supporting substrate, removing the carbon nanotubes from the supporting substrate to make them interconnected to form strings of the carbon nanotubes and stretching the strings of the carbon nanotubes to form the conductive film. The conductive film is subjected to a laser treatment that removes a portion of the conductive film by burning the portion of the conductive film with a laser beam so as to increase a light transmissibility of the conductive film.

The conductive film treated by the laser beam is subsequently attached to a base substrate in a relatively slow speed to prevent breakage of the conductive film. However, the method is disadvantageous in that since the conductive film is in a suspended condition during the laser treatment, a middle portion of the conductive film tends to sink by gravity, which results in an unstable operation in removing the portion of the conductive film and in a decrease in the production rate and yield.

Since the density of the conductive film is considerably decreased after the laser treatment, the mechanical strength of the conductive film is significantly decreased. Therefore, it makes the conductive film to be vulnerable to the ambient air flow resulting from movement of mechanical parts or heat flows therearound, thereby decreasing the production rate and yield. Moreover, since the carbon nanotubes of the conductive film are poor in heat dissipation, the conductive film can be burned such that it is undesirably broken, which results in stopping of operation and in a decrease in the production rate and yield.

### SUMMARY OF THE DISCLOSURE

According to one aspect of the present disclosure, there is provided a method for fabricating a conductive plate. The method comprises: providing a base substrate and a conductive material that includes a plurality of nanounits and a transmissibility, placing the conductive material on the base substrate, and removing a portion of the conductive material placed on the base substrate to increase the transmissibility of the conductive film.

According to another aspect of the present disclosure, there is provided a system for fabricating a conductive plate. The system comprises: a substrate-supplying unit for supplying a base substrate, a material-supplying unit for supplying a conductive material having a transmissibility, wherein the conductive material including a plurality of nanounits, a conveying unit disposed downstream of the substrate-supplying unit for receiving the base substrate from the substrate-supplying unit and for conveying at least the base substrate, the substrate-supplying unit placing the conductive material on the base substrate conveyed by the conveying unit, a joining unit disposed downstream of the material-supplying unit, and a post-treatment unit disposed downstream of the joining unit for receiving the conductive material attached to the base substrate from the joining unit and for removing a portion of the conductive material from the base substrate to increase the transmissibility of the conductive material.

Other objects and advantages of the disclosure can be further illustrated by the technical features broadly embodied and described as follows.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a block diagram of the first exemplary embodiment of a method of the present disclosure for fabricating a conductive plate.

FIGS. 2A and 2B are perspective views to illustrate consecutive steps of how a conductive material for the conductive plate made by the first exemplary embodiment can be prepared.

FIG. 2C is a schematic side view of the conductive plate made by the first exemplary embodiment.

FIG. 2D is a schematic top view of the conductive plate made by the first exemplary embodiment.

FIG. 3 is a block diagram of a system for implementing the first exemplary embodiment of the present disclosure.

FIG. 4 is a block diagram of the second exemplary embodiment of a method of the present disclosure for fabricating a conductive plate.

FIG. 5 is a block diagram of a system for implementing the second exemplary embodiment of the present disclosure.

### DESCRIPTION OF EMBODIMENTS

Reference will now be made to the drawings to describe various embodiments in detail.

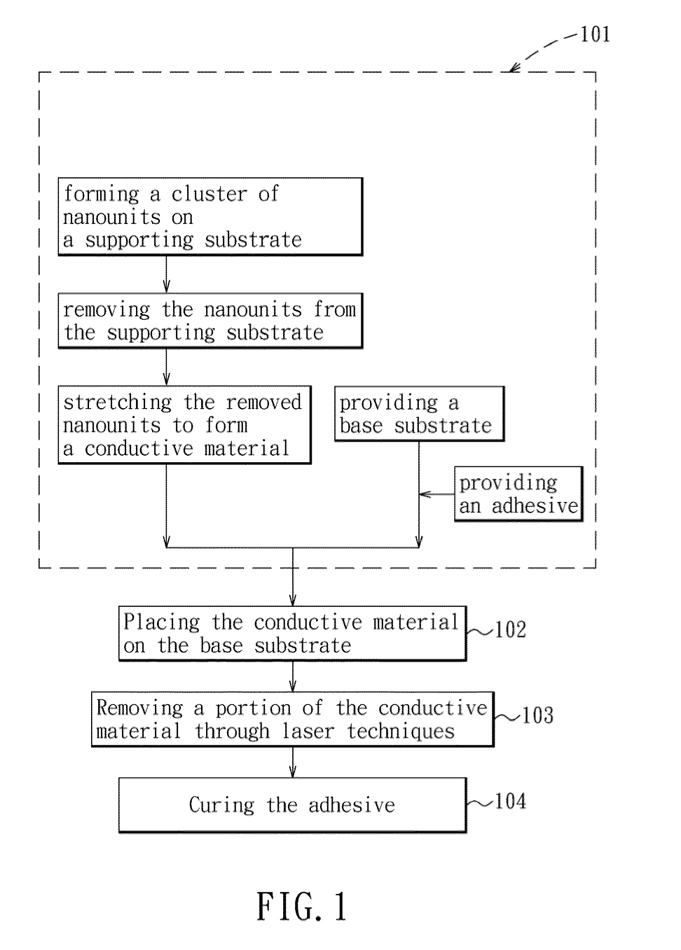

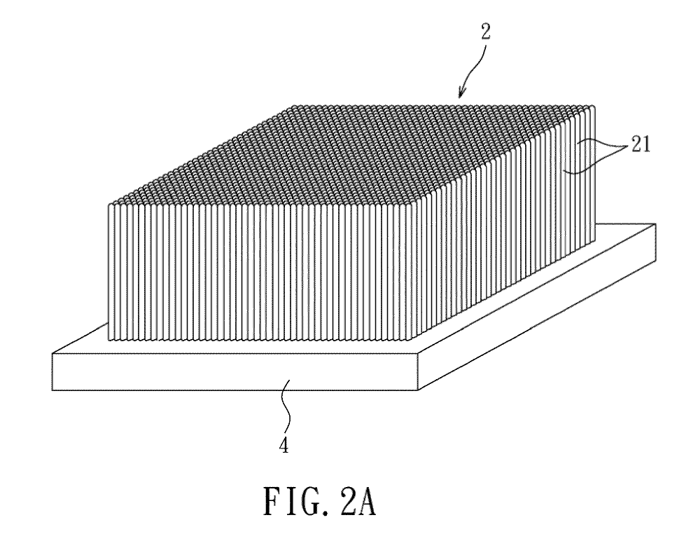

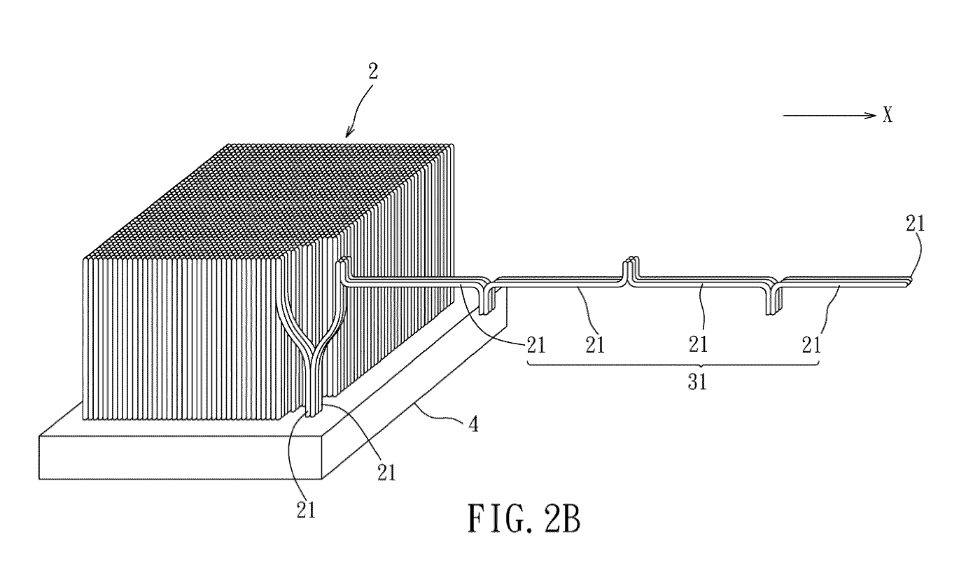

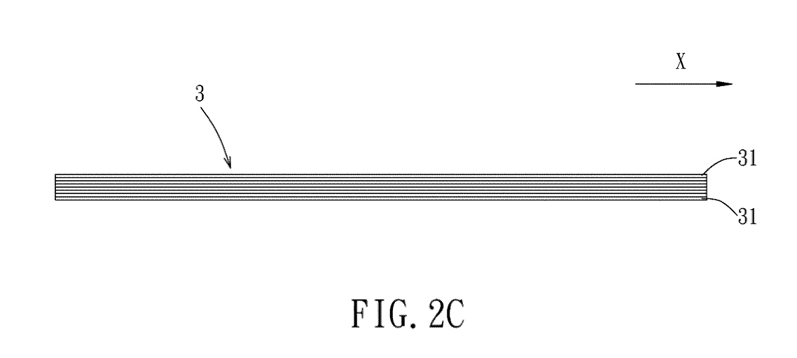

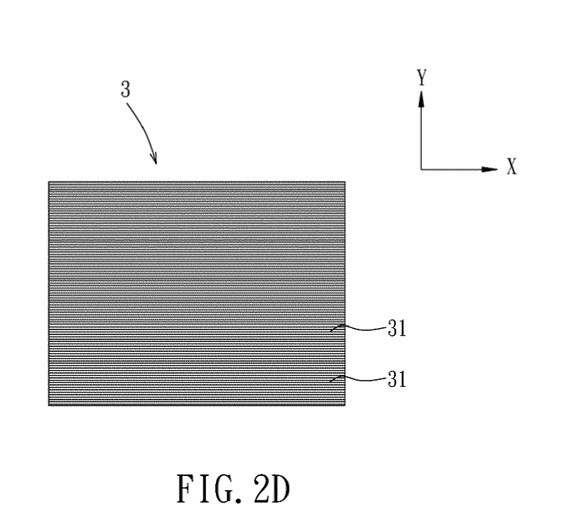

Referring to FIG. 1, in combination with FIGS. 2A to 2D, the first exemplary embodiment of a method of the present disclosure for fabricating a conductive plate includes the following steps. A base substrate 33 and a conductive material 3 having a transmissibility is provided (see FIGS. 2A and 2B) in step 101, wherein the conductive material 3 including a plurality of nanounits. Then, the conductive material 3 is placed on the base substrate 33 in step 102 (see FIG. 2C). After that, a portion of the conductive material 3 placed on the base substrate 33 is removed in step 103 to increase the transmissibility of the conductive material 3.

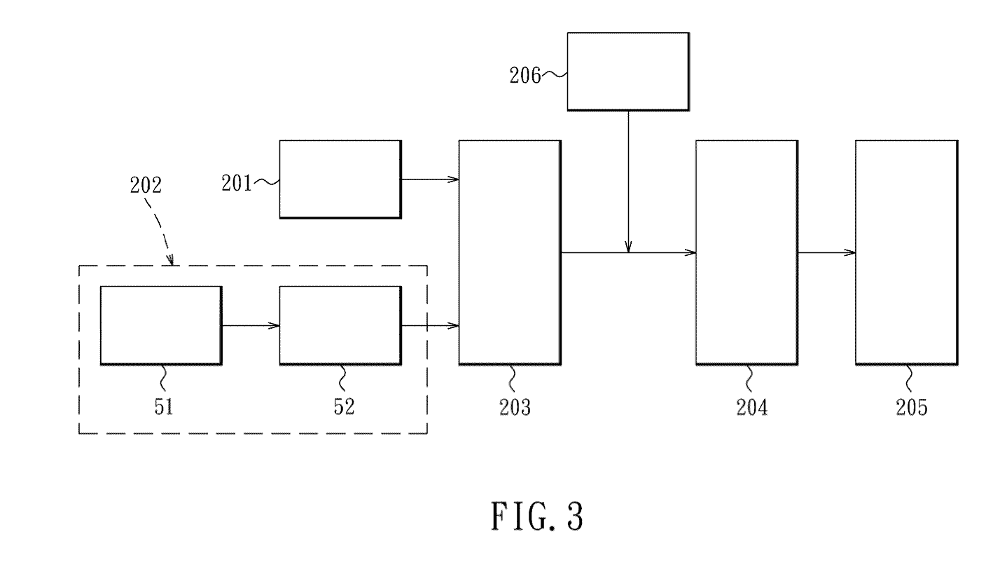

Referring to FIG. 3, in combination with FIG. 1 and FIGS. 2A to 2D, the method of the first exemplary embodiment is implemented by a system that includes: a substrate-supplying unit 201 for supplying the base substrate 33, a material-supplying unit 202 for supplying the conductive material 3, a conveying unit 203 disposed downstream of the substrate-supplying unit 201 for receiving the base substrate 33 from the substrate-supplying unit 33 and the conductive material 3 from the material-supplying unit 202 and for conveying the base substrate 33 and the conductive material 3, the substrate-supplying unit 201 placing the conductive material 3 on the base substrate 33 conveyed by the conveying unit 203, a joining unit 204 disposed downstream of the material-supplying unit 202, and

The method of the first exemplary embodiment is implemented by a system further includes a post-treatment unit 205 disposed downstream of the joining unit 204 for receiving the conductive material 3 attached to the base substrate 33 from the joining unit 204 and for removing the portion of the conductive material 3 from the base substrate 33. The material-supplying unit 202 includes a nanomaterial-forming device 51 and a film-stretching device 52.

The conductive material 3 is prepared by forming a cluster 2 of the nanounits 21 on a supporting substrate 4 (see FIG. 2A) through the nanomaterial-forming device 51. The nanomaterial-forming device 51 uses techniques, such as chemical vapor deposition techniques, laser vaporization vapor deposition techniques, or arc discharge vaporization vapor deposition techniques. After that, the cluster 2 of the nanounits 21 on a supporting substrate 4 are removed in a pulling manner from the supporting substrate 4 to make them interconnected to form strings 31 of the nanounits 21 and subsequently stretching the strings 31 of the nanounits 21 along a first direction (X) to form the conductive material 3 using the film-stretching device 52.

The nanounits 21 of each string 31 of the conductive material 3 are interconnected through Van der Waals' interaction and are connected in series to one another along the first direction (X) in an end-to-end manner. The nanounits 21 may be nanotube bundles, nanotubes (anisotropic in shape), or nanoparticles (isotropic in shape).

In the embodiment, the nanounits 21 are carbon nanotube bundles. The strings 31 of the nanounits 21 extend along the first direction (X), and are distributed along a second direction (Y) different from the first direction (X) (see FIG. 2D). In this exemplary embodiment, the first and second directions (X, Y) are transverse to each other. The conductive material 3 exhibits electric anisotropy and has a much higher conductivity or a much lower resistivity in the first direction (X) than that in the second direction (Y). The material-supplying unit 202 can further includes a supplying reel (not shown) for winding of the conductive material 3 thereon and for supplying the conductive material 3 to the conveying unit 203.

The substrate-supplying unit 201 can be a supplying reel (not shown) wound with the base substrate 33 for supplying the base substrate 33 to the conveying unit 203. The base substrate 33 can be made of a transparent material, such as glass and a transparent polymeric material. Examples of the polymeric material include but are not limited to polymethylmethacrylate (PMMA) board, polyethylene terephthalate (PET) board, and polycarbonate (PC) board. In addition, the base substrate 100 can also be made of an opaque material, such as metal, semiconductors, printed circuit boards, colored plastic boards, and plastic boards coated with a color layer.

The conveying unit 203 can includes a conveyor or a set of rollers (not shown) to transport the base substrate 33 and the conductive material 3 to the joining unit 204. The joining unit 204 can be a rotary roller or a mechanical device (not shown) suitable for attaching the conductive material 3 to the base substrate 33.

The first exemplary embodiment further includes applying an adhesive 32 on the base substrate 33 prior to placement of the conductive material 3 on the base substrate 33 using an adhesive applicator 206 so that the conductive material 3 is attached adhesively to the base substrate 33 through the adhesive 32. The first exemplary embodiment further includes curing the adhesive 32 in step 104 after step 103.

Selection of the adhesive 20 depends on the type of curing to be used in bonding the conductive layer 30 to the base substrate 10. For example, when the adhesive 200 is a light curable adhesive (such as an ultraviolet glue), the adhesive 200 is cured by irradiation with a light having a specified wavelength range; or when the adhesive 200 is a heat curable adhesive, the adhesive 200 is cured over an elevated temperature; or when the adhesive 200 is a light-heat curable adhesive, the adhesive 200 is cured by irradiation with the light having a specified wavelength range over an elevated temperature. In addition, the adhesive 20 can also be selected from conductive adhesives, such as a conductive polymer adhesive.

The step of removing the portion of the conductive material 3 from the base substrate 33 is conducted by irradiating the conductive material 3 with a laser beam so as to burn the desired portion of the conductive material 3. The post-treatment unit 205 includes a laser means (not shown) that is configured to generate the laser beam emitting toward the conductive material 3. The laser means can be operated in a manner that the laser beam is moved in the first direction (X) from a front end 331 of the conductive material 3 to a rear end 332 of the conductive material 3 and is further moved back-and-forth in the second direction (Y) between a left end 341 of the conductive material 3 and a right end 342 of the conductive material 3 during movement from the front end 331 to the rear end 332 of the conductive material 3, or in a manner that the laser beam is moved in the second direction (Y) from the left end 341 of the conductive material 3 to the right end 342 of the conductive material 3 and is further moved back-and-forth in the first direction (X) between the front end 331 of the conductive material 3 and the rear end 332 of the conductive material 3 during movement from the left end 341 to the right end 342 of the conductive material 3.

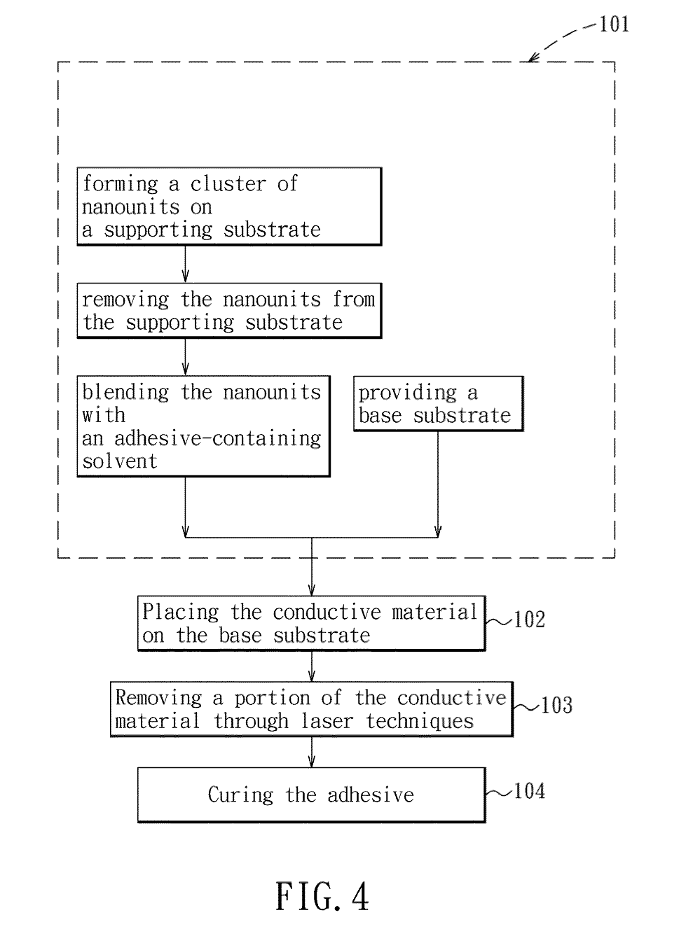

FIG. 4 illustrates the second exemplary embodiment of a method of the present disclosure for fabricating a conductive plate. The second exemplary embodiment differs from the previous exemplary embodiment in that the nanounits 21 removed from the supporting substrate 4 in step 101 are blended with an adhesive-containing solvent to form the conductive material 3, that the conductive material 3 is applied to the base substrate 33 in step 102.

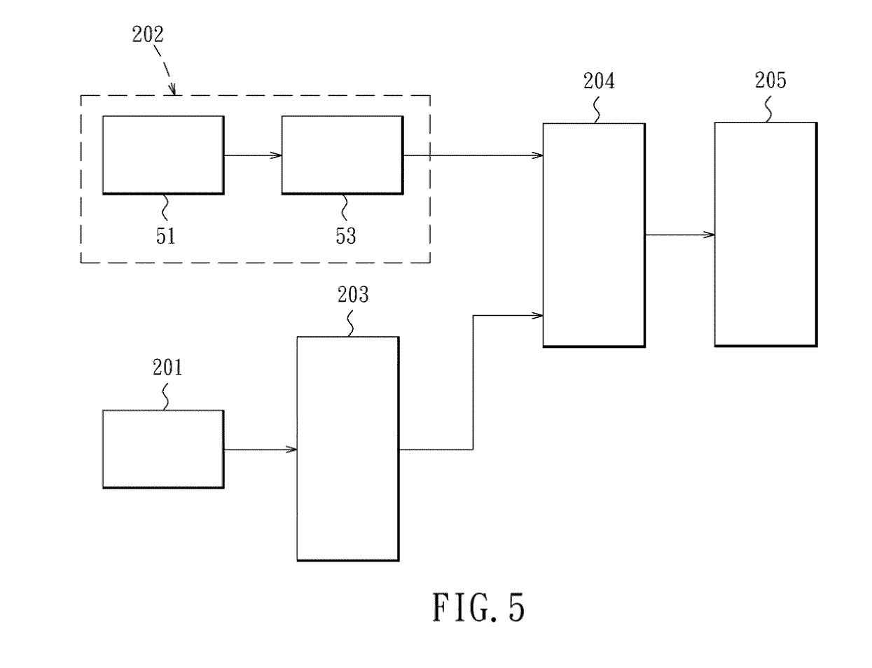

Referring to FIG. 5, the method of the second exemplary embodiment is implemented by a system differing from the previous system in that the material-supplying unit 202 of this exemplary embodiment includes the material-forming device 51 and a mixer 53 suitable for mixing the nanounits 21 and the adhesive-containing solvent to form the conductive material 3, that the joining unit 204 is an applicator suitable for applying the conductive material 3 to the base substrate 33 through techniques, such as liquid drop coating and printing techniques. Note that the mixer 53 and the applicator of the joining unit 204 can be integrally formed as a single device.

The adhesive-containing solvent can contains a conductive adhesive or a polymeric adhesive.

In summary, by attaching the conductive material 3 to the base substrate 33, followed by removing the portion of the conductive material 3 through the laser treatment according to the method of this disclosure, the aforesaid drawback associated with the prior art can be eliminated.

It is to be understood that even though numerous characteristics and advantages of the present embodiments have been set forth in the foregoing description, together with details of the structures and functions of the embodiments, the disclosure is illustrative only; and that changes may be made in detail, especially in matters of shape, size, and arrangement of parts, within the principles of the embodiments, to the full extent indicated by the broad general meaning of the terms in which the appended claims are expressed.

What is claimed is:

1. A method for fabricating a conductive plate, comprising:
providing a base substrate and a conductive material having a transmissibility, wherein the conductive material including a plurality of nanounits;
placing the conductive material on the base substrate; and
removing a portion of the conductive material placed on the base substrate to increase the transmissibility of the conductive material.

2. The method of claim 1, wherein the step of removing the portion of the conductive material placed on the base substrate is conducted by irradiating the conductive material with a laser beam.

3. The method of claim 2, wherein the conductive material is attached onto the base substrate through an adhesive.

4. The method of claim 3, further comprising curing the adhesive.

5. The method of claim 4, wherein the step of curing the adhesive is performed prior to the irradiation of the conductive material with the laser beam.

6. The method of claim 1, wherein the conductive material is formed by:
forming a cluster of the nanounits on a supporting substrate;
removing the nanounits from the supporting substrate to make the nanounits interconnected to form strings of the nanounits; and
stretching the strings of the nanounits to form the conductive material.

7. The method of claim 6, wherein the nanounits of each of the strings are interconnected through Van der Waals' interaction.

8. The method of claim 6, wherein the nanounits of each of the strings are connected in series to one another along a direction.

9. The method of claim 1, wherein the conductive material is formed by:
forming a cluster of the nanounits on a supporting substrate;
removing the nanounits from the supporting substrate; and
blending the nanounits removed from the supporting substrate with an adhesive-containing solvent to form the conductive material.

10. The method of claim 9, wherein the nanounits are carbon nanotube bundles.

11. The method of claim 1, wherein the conductive material exhibits electric anisotropy.

12. The method of claim 1, wherein the nanounits are carbon nanotube bundles.

13. The method of claim 1, wherein the base substrate is flexible.

14. The method of claim 1, wherein the nanounits is interconnected to form strings of the nanounits, the nanounits of each of the strings being interconnected in series to one another along a first direction, the strings of the nanounits being distributed and aligned with one another along a second direction different from the first direction.

15. The method of claim 14, wherein a laser beam is moved in the first direction from a front end of the conductive material to a rear end of the conductive material and is further moved back-and-forth in the second direction between a left end of the conductive material and a right end of the conductive material during movement from the front end to the rear end of the conductive material.

16. The method of claim 14, wherein a laser beam is moved in the second direction from a left end of the conductive material to a right end of the conductive material and is further moved back-and-forth in the first direction between a front end of the conductive material and a rear end of the conductive material during movement from the left end to the right end of the conductive material.

17. A system for fabricating a conductive plate, comprising:
a substrate-supplying unit for supplying a base substrate;
a material-supplying unit for supplying a conductive material having a transmissibility, wherein the conductive material including a plurality of nanounits;
a conveying unit disposed downstream of the substrate-supplying unit for receiving the base substrate from the substrate-supplying unit and for conveying at least the base substrate, wherein the substrate-supplying unit places the conductive material on the base substrate conveyed by the conveying unit;
a joining unit disposed downstream of the material-supplying unit; and
a post-treatment unit disposed downstream of the joining unit for receiving the conductive material attached to the base substrate from the joining unit and for removing a portion of the conductive material from the base substrate to increase the transmissibility of the conductive material .

18. The system of claim 17, wherein the post-treatment unit is configured to generate a laser beam that emits toward the conductive material on the base substrate so as to remove the portion of the conductive material from the base substrate.

19. The system of claim 17, wherein the material-supplying unit includes a nanomaterial-forming device that is configured to form a cluster of the nanounits on a supporting substrate, and a film-stretching device that is configured to remove the nanounits from the supporting substrate to make the nanounits interconnected to form strings of the nanounits and to stretch the strings of the nanounits to form the conductive material.

20. The system of claim 17, wherein the nanounits is interconnected to form strings of the nanounits, the nanounits of each of the strings being interconnected in series to one another along a first direction, the strings of the nanounits being distributed and aligned with one another along a second direction different from the first direction.

21. The system of claim 20, wherein the post-treatment unit is configured to emit a laser beam in such a manner that the laser beam is moved in the first direction from a front end of the conductive material to a rear end of the conductive material and is further moved back-and-forth in the second direction between a left end of the conductive material and a right end of the conductive material during movement from the front end to the rear end of the conductive material.

22. The system of claim 20, wherein the post-treatment unit is configured to emit a laser beam in such a manner that the laser beam is moved in the second direction from a left end of the conductive material to a right end of the conductive material and is further moved back-and-forth in the first direction between a front end of the conductive material and a rear end of the conductive material during movement from the left end to the right end of the conductive material.

23. The system of claim 17, further comprising an adhesive applicator disposed downstream of the substrate-supplying unit for applying an adhesive to the base substrate, the conductive material being attached to the base substrate through the adhesive by the joining action of the joining unit.

24. The system of claim 17, wherein the material-supplying unit includes a nanomaterial-forming device that is configured to form a cluster of the nanounits on a supporting substrate, to remove the nanounits from the supporting substrate and to blend the nanounits removed from the supporting substrate with an adhesive-containing solvent to form the conductive material.

25. The system of claim 24, wherein the post-treatment unit is configured to generate a laser beam that emits toward the conductive material on the base substrate so as to remove the portion of the conductive material from the base substrate.
